(19) United States
(12) Patent Application Publication
(10) Pub. No.: US 2017/0250827 A1
(43) Pub. Date: Aug. 31, 2017

(54) TRUST ANCHOR UPDATE IN A PUBLIC KEY INFRASTRUCTURE

(71) Applicant: NOKIA SOLUTIONS AND NETWORKS OY, Espoo (FI)

(72) Inventors: Juergen OPSCHROEF, Straelen (DE); Shekhar KUMAR, Ranchi, Jharkhand (IN); Martin Karl PEYLO, Espoo (FI); Michal SZYMANSKI, Warsaw (PL); Giangiacomo GUGLIELMINI, Ulm (DE); Hua LI, Munich (DE)

(73) Assignee: Nokia Solutions and Networks OY, Espoo (FI)

(21) Appl. No.: 15/505,515

(22) PCT Filed: Aug. 22, 2014
(86) PCT No.: PCT/EP2014/067920

§ 371 Date: Feb. 21, 2017

(51) Int. Cl. H04L 9/32; H04L 9/00; H04L 9/08; H04L 29/06

(52) U.S. Cl. CPC H04L 9/3268; H04L 63/0823; H04L 9/006; H04L 9/088; H04L 9/0891; H04L 9/321

(57) ABSTRACT

There are provided measures for trust anchor update in a public key infrastructure. Such measures exemplarily comprise, for managing, in a network utilizing authentication based on certificates for secure connections between end entities, an update from an old trusted anchor certificate to a new trusted anchor certificate, wherein each of said trusted anchor certificates is a root point of a chain of certificates, providing, for a pre-migration period, said old trusted anchor certificate as valid, providing, for a migration period, said old trusted anchor certificate and said new trusted anchor certificate, coincidentally, as valid, and providing, for a post-migration period, said new trusted anchor certificate as valid.

### FIELD

The present invention relates to trust anchor update in a public key infrastructure. More specifically, the present invention exemplarily relates to measures (including methods, apparatuses and computer program products) for realizing trust anchor update in a public key infrastructure.

### BACKGROUND

The present specification generally relates to certificate based authentication framework in mobile networks which is also known as public key infrastructure (PKI). Amongst other use cases, PKI frameworks are used for authentication in internet protocol security (IPsec) and transport layer security (TLS)/secure sockets layer (SSL) connections. In order to enable network elements (NE) to establish secure TLS or IPsec connections with each other, end entity (EE) certificates and related trust anchor (TA) certificates are required to be installed in the NEs. In large networks, certificate management can be automated by using a certificate management protocol (CMP).

FIG. 1 is a schematic diagram illustrating a general network deployment in which a secure connection is established between end entity A and end entity B.

Both end entities are provided with a common trusted anchor, and each end entity has a certificate which is respectively signed with the private key related to the common trust anchor's certificate.

It is known to use CMP for automation of PKI roll out in networks. One of the most important elements in a PKI is the trust anchors present on and used by the end entities. These trust anchors are usually self signed certificates which are at the top of any certificate based trust chain. These trust anchors finally guide the end entities about whether to proceed with the set up of secure connections (TLS/IPSec) or to abort the set up process.

These trust anchors are also certificates. Hence, they have a finite life time and are determined to expire.

Since these trust anchors are a root of trust for authenticating the peers for authentication requests, once these trust anchors expire, the end entities are not able to establish secure network connections with other nodes. Specifically in terms of mobile networks this might mean that hundreds of geographically widely distributed nodes lose the network connection needed to provide their intended functionality.

A delivery of the trust anchor to the end entity is specified (3^{rd} Generation Partnership Project (3GPP)) as part of the initial bootstrapping into the PKI using the initial request (IR) message of CMP protocol. However, any trust anchor update like defined in RFC4210, chapter 5.3.13 (CMP announcement by CA), is not provided for.

TA certificates have a limited lifetime after which they expire and are not valid anymore. This makes it necessary to exchange the TA certificates with a new one on a regular basis. As the TA certificates lifetime usually also limits the validity of the EE certificates it issues, the new TA will eventually also sign new EE certificates to be deployed to the EEs.

Current practice involves manual intervention from the operators, partially defeating the purpose of having complete automation of PKI roll out. Such difficulty is further compounded by the fact that in a big PKI network it is not feasible to migrate all end entities to a new trust anchor at the same time. This can create severe interoperability issues between the EEs intended to be peers connected by a secure connection.

FIG. 2 is a schematic diagram illustrating a risk of connection loss in a general network deployment. In particular, in the network deployment in FIG. 2 a secure connection between end entity (peer) A and end entity (peer) B is broken.

Namely, while peer A is already provided with a new trust anchor and accordingly with a new end entity certificate (EEA's certificate) signed with the private key related to the new trust anchor's certificate, peer B is still provided with the old trust anchor, and its end entity certificate (EEB's certificate) is signed with the private key related to the old trust anchor's certificate.

In particular, if a new TA with a new EE certificate is installed at peer A, the secure connection might be broken when
peer A automatically re-establishes the secure connection triggered by the installation of the new certificates, or when
peer A or peer B performs a rekey with authentication.

In that case the secure connection cannot be established, because peer B does not possess and utilize the new TA yet.

The migration between an old and a new TA might be done by means of cross-certifying the old and the new trust anchor, respectively, and certain relevant sub CAs within the old and the new PKI hierarchies. However, cross-certification might not always be desired, and may entail some disadvantages.

In detail, FIG. 12 is a schematic diagram illustrating timings of a trust anchor update with cross-certification.

FIG. 13 is a schematic diagram illustrating a connection establishment (TA update) using cross-certification.

According thereto, the migration between an old and a new TA is done by means of cross-certifying the old and the new trust anchor, respectively, and certain relevant sub CAs within the old and the new PKI hierarchies.

As shown in FIG. 13, a secure connection between an EE which has not yet received the new TA (i.e. EEA) and an EE which has already received the new TA (i.e. EEB) can be established as follows.

EEA holds an EEA certificate signed by the old TA, EEB holds both, the old and the new TA and EEB's certificate signed by the new CA2. Additionally, two cross certificates have been conveyed to EEB. Namely, an xCert X1 where the old TA has signed the new TA, and an xCert X2 where the new TA has signed the old TA.

In such case, a secure connection can be established, when the EEA delivers EEA's trust chain to EEB while EEB can authenticate its peer via the old TA, or when the EEB delivers EEB's certificate, CA2 certificate, and the cross-certificate X1 to EEA. EEA can then build a trust chain to its old TA via X1.

With respect to cross-certificates it is noted that not all protocols support the delivery of a trust chain (e.g. IKEv1), and that some PKI configurations do not allow the usage of cross-certificates for authentication (see e.g. authority key identifier (AKI)).

However, if cross-certification is not done, EEs not yet having the new TA are not able to validate certificates having their certification path ending in the new TA. This would lead to interoperability issues between the EEs connected by a secure connection (see also FIG. 2).

In order to update a trust anchor (certificate), it is known to manually install the same, as mentioned above, and as currently used commonly in the 3GPP use case for trust anchor update. Such approach involves manual offline installation of the new trust anchor on all involved nodes.

According to such approach, no new implementation is needed.

However, such approach needs manual intervention, and maintenance is difficult as each individual node's situation needs to be monitored. In particular, a list of EE must be available.

In addition, according to such approach (i.e. manual installation) system security may be reduced, too, because some user might be able to install, maliciously or accidentally, a fake TA.

Furthermore, a key update is known in relation to certificate authorities (CA). Namely, according to RFC4210, chapter 5.3.13, “CA Key Update Announcement Content”, the following data structure may be used to announce this event when a CA updates its own key pair.

```
CAKeyUpdAnnContent ::= SEQUENCE {
      oldWithNew Certificate,
      newWithOld Certificate,
      newWithNew Certificate
}
```

FIG. 3 is a schematic diagram illustrating a general network deployment supporting CMP announcement. In particular, in the network deployment in FIG. 3, an end entity and a CA are connected.

To communicate the announcement from the CA to the EE, mechanisms as detailed in RFC6712, section 3.7, can be used. This is done by pushing the announcement from the CA to the EE.

According to such approach, the EE automatically gets notified when new TA is available, and all end entities get the new TA almost at the same time. Furthermore, no manual intervention is necessary.

However, according to this approach, the CA needs to maintain a list of all EEs which is difficult. Especially in mobile networks EE internet protocol (IP) addresses may change dynamically. Further, a support of the above mentioned message by end entities is not required according to the 3GPP, such that a corresponding announcement may not be recognized. In fact, there is no wide support by available CMP server or client implementations for CMP announcements. In addition, for CMP announcement the roles (server, client) may depart from the usual distribution of roles in HTTP protocol.

A further possible approach for an update of a trust anchor may be EE polling. According to such approach, the end entity sends a general message to the PKI requesting details that will be required for later PKI management operations. Registration authority (RA)/CA responds with a general response. If an RA generates the response, then it will simply forward the equivalent message that it previously received from the CA, with the possible addition of certificates to the extraCerts fields of the PKIMessage. A confirmation message is not required from the end entity.

FIG. 4 is a schematic diagram illustrating a general network deployment supporting EE polling. In particular, in the network deployment in FIG. 4, an end entity and a CA are connected and exchange general messages as mentioned above.

According to such approach, no manual intervention needed.

However, such polling might result in network load issues with many EE doing periodic polling. In addition, an implementation of such a concept is not known.

Hence, the problem arises that a feasible approach is to be found for automatically updating a trust anchor. In particular, necessity of manual intervention by operators is to be avoided, and maintenance and/or management to be simplified. In doing so, network load is to be spared, while a wide support of the proposed techniques is aspired.

Hence, in general, there is a need to provide for trust anchor update in a public key infrastructure.

### SUMMARY

Various exemplary embodiments of the present invention aim at addressing at least part of the above issues and/or problems and drawbacks.

Various aspects of exemplary embodiments of the present invention are set out in the appended claims.

According to an exemplary aspect of the present invention, there is provided a method for managing, in a network utilizing authentication based on certificates for secure connections between end entities, an update from an old trusted anchor certificate to a new trusted anchor certificate, wherein each of said trusted anchor certificates is a root point of a chain of certificates, said method comprises providing, for a pre-migration period, only said old trusted anchor certificate as valid, providing, for a migration period, said old trusted anchor certificate and said new trusted anchor certificate, coincidentally, as valid, and providing, for a post-migration period, only said new trusted anchor certificate as valid.

According to an exemplary aspect of the present invention, there is provided a method for updating, in a network utilizing authentication based on certificates for secure connections between end entities, from an old trusted anchor certificate to a new trusted anchor certificate, wherein each of said trusted anchor certificates is a root point of a chain of certificates, said method comprises conducting a secure connection, wherein for a migration period, said old trusted anchor certificate and said new trusted anchor certificate are coincidentally valid for said conducting.

According to an exemplary aspect of the present invention, there is provided an apparatus for managing, in a network utilizing authentication based on certificates for secure connections between end entities, an update from an old trusted anchor certificate to a new trusted anchor certificate, wherein each of said trusted anchor certificates is a root point of a chain of certificates, said apparatus comprises providing means configured to provide, for a pre-migration period, only said old trusted anchor certificate as valid, to provide, for a migration period, said old trusted anchor certificate and said new trusted anchor certificate, coincidentally, as valid, and to provide, for a post-migration period, only said new trusted anchor certificate as valid.

According to an exemplary aspect of the present invention, there is provided an apparatus for updating, in a network utilizing authentication based on certificates for secure connections between end entities, from an old trusted anchor certificate to a new trusted anchor certificate, wherein each of said trusted anchor certificates is a root point of a chain of certificates, said apparatus comprises conducting means configured to conduct a secure connection, wherein for a migration period, said old trusted anchor certificate and said new trusted anchor certificate are coincidentally valid for said conducting.

According to an exemplary aspect of the present invention, there is provided a computer program product comprising computer-executable computer program code which, when the program is run on a computer (e.g. a computer of an apparatus according to any one of the aforementioned apparatus-related exemplary aspects of the present invention), is configured to cause the computer to carry out the method according to any one of the aforementioned method-related exemplary aspects of the present invention.

Such computer program product may comprise (or be embodied) a (tangible) computer-readable (storage) medium or the like on which the computer-executable computer program code is stored, and/or the program may be directly loadable into an internal memory of the computer or a processor thereof.

Any one of the above aspects enables an efficient automatic trust anchor update to thereby solve at least part of the problems and drawbacks identified in relation to the prior art.

In particular, according to exemplary embodiments of the present invention, an automated TA update procedure is provided, such that no manual interaction is necessary. The techniques according to exemplary embodiments avoid network load as EEs do not poll for new TAs. Furthermore, the CA does not need to keep track of the EEs. Moreover, it is not necessary to have a list of the EEs available. A usage of the “CA Key Update Announcement Content” according to exemplary embodiments of the present invention triggers the EEs that a new TA is conveyed, i.e., according to some embodiments of the present invention there is no need for an algorithm to derive whether a new TA is delivered in the caPubs or extraCerts field. Exemplary embodiments of the present invention make use of and extend well known IR and key update request (KUR) procedures that are used and implemented in all EE.

By way of exemplary embodiments of the present invention, there is provided trust anchor update in a public key infrastructure. More specifically, by way of exemplary embodiments of the present invention, there are provided measures and mechanisms for realizing trust anchor update in a public key infrastructure.

Thus, improvement is achieved by methods, apparatuses and computer program products enabling/realizing trust anchor update in a public key infrastructure.

### BRIEF DESCRIPTION OF THE DRAWINGS

In the following, the present invention will be described in greater detail by way of non-limiting examples with reference to the accompanying drawings, in which

FIG. 1 is a schematic diagram illustrating a general network deployment in which a secure connection is established between end entities.

FIG. 2 is a schematic diagram illustrating a general network deployment in which a secure connection between end entities is broken.

FIG. 3 is a schematic diagram illustrating a general network deployment supporting certificate management protocol announcement.

FIG. 4 is a schematic diagram illustrating a general network deployment supporting end entity polling.

FIG. 5 is a block diagram illustrating an apparatus according to exemplary embodiments of the present invention,

FIG. 6 is a block diagram illustrating an apparatus according to exemplary embodiments of the present invention,

FIG. 7 is a block diagram illustrating an apparatus according to exemplary embodiments of the present invention,

FIG. 8 is a block diagram illustrating an apparatus according to exemplary embodiments of the present invention,

FIG. 9 is a schematic diagram of a procedure according to exemplary embodiments of the present invention,

FIG. 10 is a schematic diagram of a procedure according to exemplary embodiments of the present invention,

FIG. 11 is a schematic diagram illustrating timings of a trust anchor update according to exemplary embodiments of the present invention,

FIG. 12 is a schematic diagram illustrating timings of a trust anchor update with cross-certification,

FIG. 13 is a schematic diagram illustrating a connection establishment with cross-certification,

FIG. 14 is a block diagram alternatively illustrating apparatuses according to exemplary embodiments of the present invention.

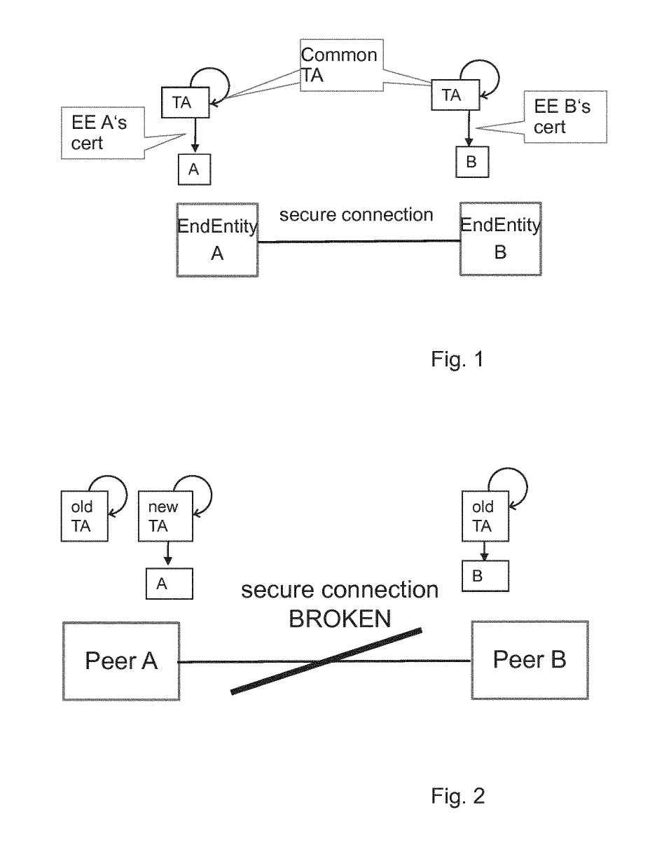

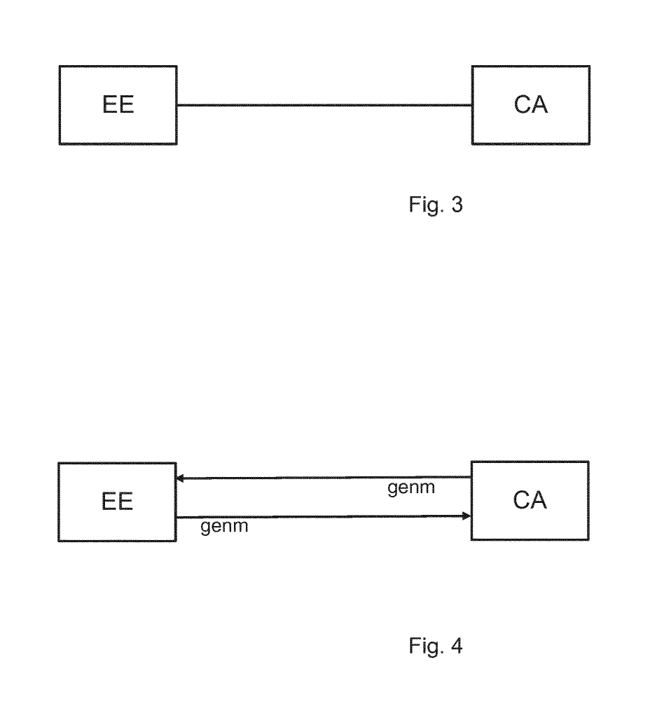

### DETAILED DESCRIPTION OF DRAWINGS AND EMBODIMENTS OF THE PRESENT INVENTION

The present invention is described herein with reference to particular non-limiting examples and to what are presently considered to be conceivable embodiments of the present invention. A person skilled in the art will appreciate that the invention is by no means limited to these examples, and may be more broadly applied.

It is to be noted that the following description of the present invention and its embodiments mainly refers to specifications being used as non-limiting examples for certain exemplary network configurations and deployments. Namely, the present invention and its embodiments are mainly described in relation to 3GPP specifications being used as non-limiting examples for certain exemplary network configurations and deployments. As such, the description of exemplary embodiments given herein specifically refers to terminology which is directly related thereto. Such terminology is only used in the context of the presented non-limiting examples, and does naturally not limit the invention in any way. Rather, any other communication or communication related system deployment, etc. may also be utilized as long as compliant with the features described herein.

Hereinafter, various embodiments and implementations of the present invention and its aspects or embodiments are described using several variants and/or alternatives. It is generally noted that, according to certain needs and constraints, all of the described variants and/or alternatives may be provided alone or in any conceivable combination (also including combinations of individual features of the various variants and/or alternatives).

According to exemplary embodiments of the present invention, in general terms, there are provided measures and mechanisms for (enabling/realizing) trust anchor update in a public key infrastructure.

According to exemplary embodiments of the present invention, the problem of trust anchor update in PKIs utilizing a certificate management protocol is addressed. In particular, according to exemplary embodiments of the present invention, existing CMP messages are used to migrate a complete PKI seamlessly to a new trust anchor.

In other words, according to exemplary embodiments of the present invention, it is provided for a TA lifecycle management at the CA, and it is proposed to extend the use of existing CMP messages to deliver an additional trust anchor to the EE.

In order to overcome problems mentioned with respect to the background art, according to exemplary embodiments of the present invention, the network migration from the old TA to the new TA is done using a stepwise procedure.

Namely, in order to permit triggering the different phases of the mentioned stepwise procedure automatically, a TA lifecycle management is proposed according to the present invention. Management with respect to the TAs lifecycle means that the CA automatically correlates the EEs certificate's lifetime with the phases of the mentioned stepwise procedure.

The CA operator needs to configure time and date of the phases. This allows the CA to perform a scheduled trust anchor update autonomously.

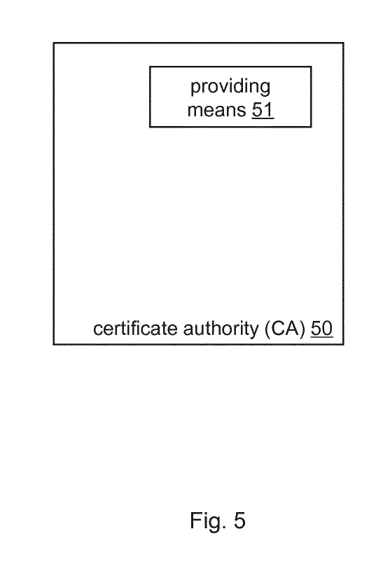

FIG. 5 is a block diagram illustrating an apparatus according to exemplary embodiments of the present invention. The apparatus may be a certificate authority 50 (which may be for managing, in a network utilizing authentication based on certificates for secure connections between end entities, an update from an old trusted anchor certificate to a new trusted anchor certificate, wherein each of said trusted anchor certificates is a root point of a chain of certificates) comprising a providing means 51. The providing means 51 provides, for a pre-migration period, only said old trusted anchor certificate as valid, and the said new trusted anchor certificate as not valid. The providing means 51 further provides, for a migration period, said old trusted anchor certificate and said new trusted anchor certificate, coincidentally, as valid. In addition, said providing means 51 provides, for a post-migration period, only said new trusted anchor certificate as valid (while said old trusted anchor being expired).

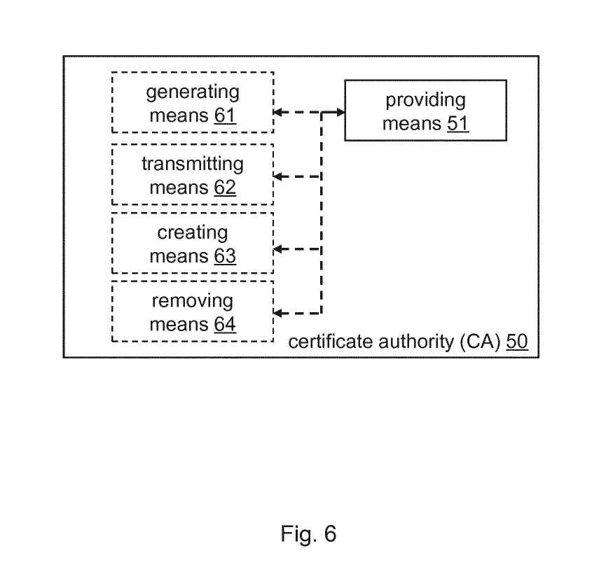

FIG. 6 is a block diagram illustrating an apparatus according to exemplary embodiments of the present invention. In particular, FIG. 6 illustrates a variation of the apparatus shown in FIG. 5. The apparatus according to FIG. 6 may thus further comprise, independently from each other, generating means 61, transmitting means 62, creating means 63, and removing means 64.

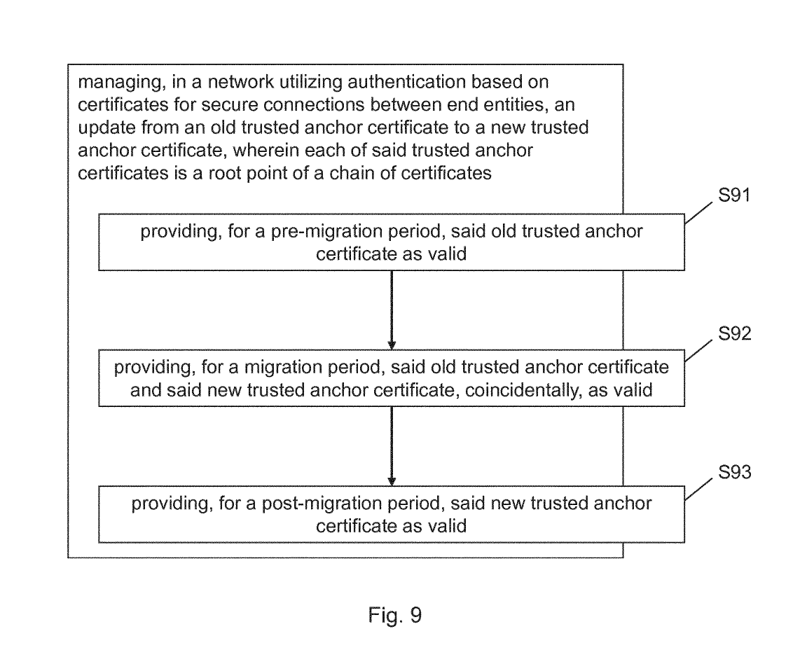

FIG. 9 is a schematic diagram of a procedure according to exemplary embodiments of the present invention. The apparatus according to FIG. 5 (or FIG. 6) may perform the method of FIG. 9 but is not limited to this method. The method of FIG. 9 may be performed by the apparatus of FIG. 5 (or FIG. 6) but is not limited to being performed by this apparatus.

As shown in FIG. 9, a procedure (for managing, in a network utilizing authentication based on certificates for secure connections between end entities, an update from an old trusted anchor certificate to a new trusted anchor certificate, wherein each of said trusted anchor certificates is a root point of a chain of certificates) according to exemplary embodiments of the present invention comprises an operation of providing (S91), for a pre-migration period, only said old trusted anchor certificate as valid, an operation of providing (S92), for a migration period, said old trusted anchor certificate and said new trusted anchor certificate, coincidentally, as valid, and an operation of providing (S93), for a post-migration period, only said new trusted anchor certificate as valid (while said old trusted anchor being expired).

According to a variation of the procedure shown in FIG. 9, exemplary details of the providing operation (providing for said pre-migration period, S91) are given, which are inherently independent from each other as such.

Such exemplary providing operation (S91) according to exemplary embodiments of the present invention may comprise an operation of generating a first certificate authority certificate signed with a private key related to said old trusted anchor certificate, an operation of generating a first end entity certificate signed with a private key related to said first certificate authority certificate, wherein said first end entity certificate is set up to expire within said migration period, and an operation of transmitting said old trusted anchor certificate, said first certificate authority certificate, and said first end entity certificate.

According to a variation of the procedure shown in FIG. 9, exemplary details of the providing operation (providing for said migration period, S92) are given, which are inherently independent from each other as such.

Such exemplary providing operation (S92) according to exemplary embodiments of the present invention may comprise an operation of creating said new trusted anchor certificate, and an operation of generating a second certificate authority certificate signed with a private key related to said new trusted anchor certificate.

According to a variation of the procedure shown in FIG. 9, exemplary details of the providing operation (providing for said migration period, S92) are given, which are inherently independent from each other as such.

Such exemplary providing operation (S92) according to exemplary embodiments of the present invention may comprise an operation of creating a first cross-certificate by signing said old trusted anchor certificate with said new trusted anchor certificate, and an operation of creating a second cross-certificate by signing said new trusted anchor certificate with said old trusted anchor certificate.

In particular, when the new trusted anchor is conveyed using the mentioned the extraCerts field, which is an unprotected field, the cross-certificates may be used to establish a trust relationship between the old and the new trusted anchors.

According to a variation of the procedure shown in FIG. 9, said migration period comprises a deployment phase and a change over phase, wherein said first end entity certificate is set up to expire within said deployment phase. According to such variation of the procedure shown in FIG. 9, exemplary details of the providing operation (providing for said migration period, S92) are given, which are inherently independent from each other as such. Such exemplary providing operation (S92) according to exemplary embodiments of the present invention may comprise an operation of generating, during said deployment phase, a second end entity certificate signed with the private key related to said first certificate authority certificate, wherein said second end entity certificate is set up to expire within said change over phase, and an operation of transmitting, during said deployment phase, said new trusted anchor certificate and said second end entity certificate.

According to a variation of the procedure shown in FIG. 9, exemplary details of the providing operation (providing for said migration period, S92) are given, which are inherently independent from each other as such.

Such exemplary providing operation (S92) according to exemplary embodiments of the present invention may comprise an operation of generating, during said change over phase, a third end entity certificate signed with a private key related to said second certificate authority certificate, and an operation of transmitting, during said change over phase, said second certificate authority certificate and said third end entity certificate.

According to a variation of the procedure shown in FIG. 9, exemplary details of the providing operation (providing for said post-migration period, S93) are given, which are inherently independent from each other as such.

Such exemplary providing operation (S93) according to exemplary embodiments of the present invention may comprise an operation of removing said old trusted anchor certificate.

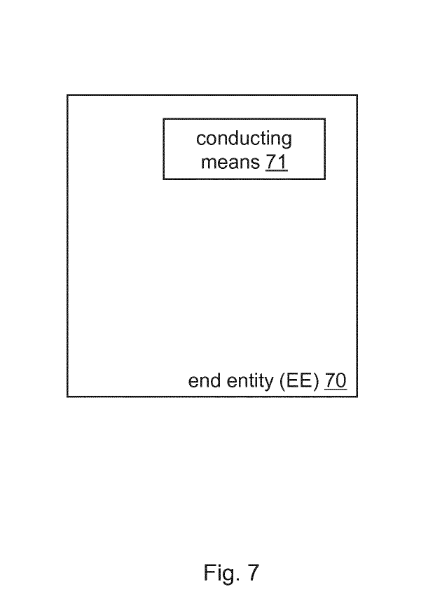

FIG. 7 is a block diagram illustrating an apparatus according to exemplary embodiments of the present invention. The apparatus may be an end entity 70 (which may be for updating, in a network utilizing authentication based on certificates for secure connections between end entities, from an old trusted anchor certificate to a new trusted anchor certificate, wherein each of said trusted anchor certificates is a root point of a chain of certificates) comprising a conducting means 71. The conducting means 71 conducts a secure connection, wherein for a migration period, said old trusted anchor certificate and said new trusted anchor certificate are coincidentally valid for said conducting.

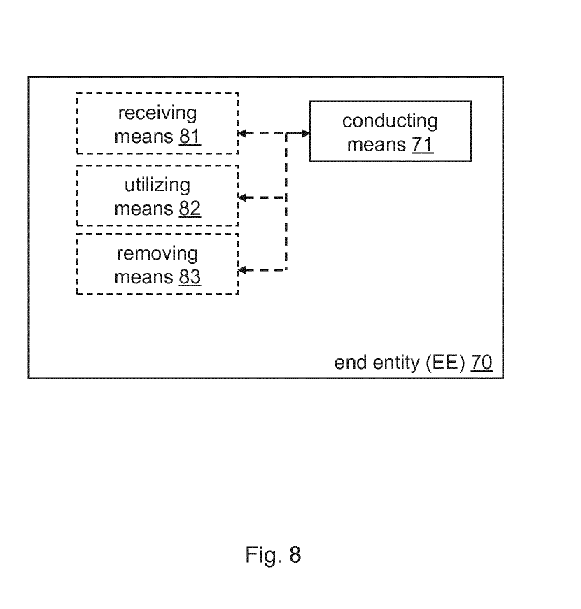

FIG. 8 is a block diagram illustrating an apparatus according to exemplary embodiments of the present invention. In particular, FIG. 8 illustrates a variation of the apparatus shown in FIG. 7. The apparatus according to FIG. 8 may thus further comprise, independently from each other, receiving means 81, utilizing means 82, and removing means 83.

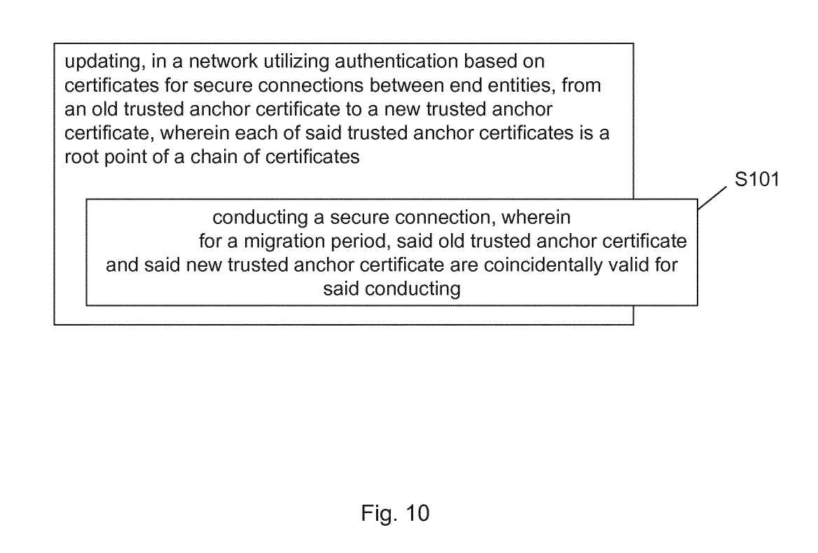

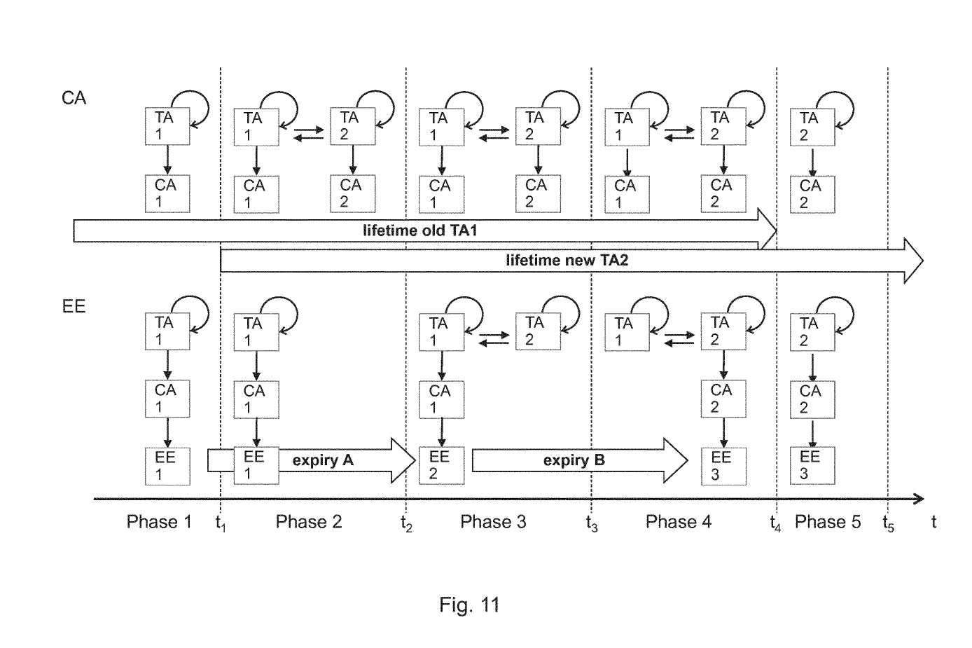

FIG. 10 is a schematic diagram of a procedure according to exemplary embodiments of the present invention. The apparatus according to FIG. 7 (or FIG. 8) may perform the method of FIG. 10 but is not limited to this method. The method of FIG. 10 may be performed by the apparatus of FIG. 7 (or FIG. 8) but is not limited to being performed by this apparatus.

As shown in FIG. 10, a procedure (for updating, in a network utilizing authentication based on certificates for secure connections between end entities, from an old trusted anchor certificate to a new trusted anchor certificate, wherein each of said trusted anchor certificates is a root point of a chain of certificates) according to exemplary embodiments of the present invention comprises an operation of conducting (S101) a secure connection, wherein for a migration period, said old trusted anchor certificate and said new trusted anchor certificate are coincidentally valid for said conducting.

According to a variation of the procedure shown in FIG. 10, exemplary additional operations are given, which are inherently independent from each other as such. According to such variation, an exemplary method according to exemplary embodiments of the present invention may comprise an operation of receiving, during a pre-migration period, a first end entity certificate signed with a private key related to a first certificate authority certificate signed with a private key related to said old trusted anchor certificate, wherein said first end entity certificate is set up to expire within said migration period, and an operation of utilizing said first end entity certificate for establishment and/or re-establishment of said secure connection during said pre-migration period.

According to a variation of the procedure shown in FIG. 10, said migration period comprises a deployment phase and a change over phase, wherein said first end entity certificate is set up to expire within said deployment phase. According to such variation of the procedure shown in FIG. 10, exemplary additional operations are given, which are inherently independent from each other as such. According to such variation, an exemplary method according to exemplary embodiments of the present invention may comprise an operation of receiving, during said deployment phase, said new trusted anchor certificate and a second end entity certificate signed with the private key related to said first certificate authority certificate, wherein said second end entity certificate is set up to expire within said change over phase, and an operation of utilizing said second end entity certificate for establishment and/or re-establishment of said secure connection during said deployment phase.

According to a variation of the procedure shown in FIG. 10, exemplary additional operations are given, which are inherently independent from each other as such. According to such variation, an exemplary method according to exemplary embodiments of the present invention may comprise an operation of receiving, during said change over phase, a second certificate authority certificate signed with a private key related to said new trusted anchor certificate, and a third end entity certificate signed with a private key related to said second certificate authority certificate, and an operation of utilizing said third end entity certificate for establishment and/or re-establishment of said secure connection during said change over phase.

According to a variation of the procedure shown in FIG. 10, exemplary additional operations are given, which are inherently independent from each other as such. According to such variation, an exemplary method according to exemplary embodiments of the present invention may comprise an operation of removing said old trusted anchor certificate during a post-migration period.

The above mentioned is explained in other words with reference to FIG. 11.

FIG. 11 is a schematic diagram illustrating timings of a trust anchor update according to exemplary embodiments of the present invention. In particular, in FIG. 11, phases of a managed TA lifecycle according to exemplary embodiments of the present invention are shown for CA and EE.

FIG. 11 describes the phases (for CA and EE) to migrate from an expiring (old) trust anchor to a new trust anchor.

In a phase 1, a trust anchor certificate (“TA1”) and a signing CA certificate (“CA1”) are installed in the CA and in all EEs. The CA1 issued an EE certificate (“EE1”). The TA will expire at time t=t4, hence it is called “old TA”. Note that the certificate lifetime of EE1 is chosen by the signing CA CA1 such that it (EE1) expires in phase 3.

In a phase 2, a new TA certificate (“TA2”) and optionally two cross certificates are created. This TA will replace the old TA and hence is called “new TA”. Note that the new TA is not yet deployed to EEs. As the CA1s certificate lifetime is bound to the old TA's lifetime and hence will expire, too, a new CA2 certificate is created, too.

A phase 3 is used to deploy the new trust anchor TA2 to all EEs. As explained in phase 1, the EE's certificate expires in phase 3 and therefore it either renews or re-keys its certificate by means of a CMP key update request, that is, therefore the EE performs a CMP key update automatically. The CA1 selects the lifetime of the new EE certificate such that it will again expire in phase 4. The new TA certificate (TA2), optionally two cross-certificates, and the new EE's certificate (“EE2”) are conveyed using the CMP key update response (KUP) message. In particular, the new TA certificate (TA2) is installed in the EE as an additional trust anchor. Note that the CA still issues EE certificates using the private key of the old TA. At the end of phase 3 all EE have the new TA deployed.

In a phase 4 the EE's certificate expires. Hence, the EE performs a CMP key update, again. In this phase all EEs are deployed with EE certificates signed by the private key of the new TA2. At the end of phase 4 all EEs have installed a new certificate. When the EE performs a CMP key update, it signs the CMP message with a private key related to EE2's certificate. This certificate has been signed by a private key related to CA1's certificate. The CA will accept the CMP key update only, if the CA still has a trust relationship with CA1.

The operator has the responsibility of maintaining the trust relationship between the old TA certificate and the new TA certificate.

It practically is not possible to perform this step simultaneously in all EEs. Nevertheless, there is no interoperability risk because EEs in phase 4 can connect with EEs that are still in phase 3. In fact EEs in phase 3 can authenticate EEs in phase 4 by the old TA, and EE in phase 4 can authenticate EEs in phase 3 by using the new TA.

In a phase 5, the old TA is taken out of use as it expires and/or is deleted from the CA and from all EEs.

It is noted that according to exemplary embodiments of the present invention phase 1 may correspond to a pre-migration period, phases 2 to 4 may correspond to a migration period, and phase 5 may correspond to a post-migration period. In the migration period, phase 3 may correspond to a deployment phase, and phase 4 may correspond to a change over phase.

During initial registration of an EE, according to exemplary embodiments of the present invention the trust anchor may be delivered as follows.

An EE performing an initial registration using a CMP initialization request and response may perform the following actions depending on the phase.

In the phase 1, the EE receives the old TA's certificate, the signing CA's certificate and the EE's certificate in the CMP initialization response. The old TA might be delivered using the caPubs or the extraCerts field. Note that the EE's certificate lifetime has been chosen by the signing CA CA1 such that it expires in phase 3.

In the phase 2, the EE receives the old TA's certificate, the signing CA's certificate and the EE's certificate in the CMP initialization response. The old TA might be delivered using the caPubs or the extraCerts field. Note that the EE's certificate lifetime has been chosen by the signing CA CA1 such that it expires in phase 3 (i.e. same as in phase 1).

In the phase 3, an EE performing an initial registration needs to receive both, the old and the new TA. This is because the EE might need to establish a secure connection to an EE which hasn't yet retrieved the new TA. Note that the EE's certificate lifetime has been chosen by the signing CA CA1 so that it expires in phase 4.

In the phase 4, an EE performing an initial registration needs to receive both, the old and the new TA to ensure secured connection to the EE still in phase 3. This is because all other EE have already received the new TA but not necessarily a new corresponding CA's and EE's certificate (i.e. EEs still in phase 3). Namely, EEs in phase 3 authenticate using the old EE certificate (signed with the private key related to the old CA certificate signed with the private key related to the old TA certificate).

In the phase 5, an EE performing an initial registration just needs to receive the new TA. This is because all other EE have already received the new TA.

According to exemplary embodiments, existing CMP messages may be used to deliver the trust anchor to the EE.

Namely, according to a variation of the procedure shown in FIG. 9, according to exemplary embodiments of the present invention said new trusted anchor certificate is transmitted in a caPubs field of a key response message, and/or in a generalInfo field of a public key infrastructure header of a certificate management protocol message in a key response message, and/or in an extraCerts field in a key response message.

Correspondingly, according to a variation of the procedure shown in FIG. 10, according to exemplary embodiments of the present invention said new trusted anchor certificate is received in a caPubs field of a key response message, and/or in a generalInfo field of a public key infrastructure header of a certificate management protocol message in a key response message, and/or in an extraCerts field in a key response message.

That is, according to exemplary embodiments of the present invention, for delivering the trust anchor to the EE in an efficient way, the use of existing CMP messages is extended.

The EE already requests a new certificate when the EE's (own) end entity certificate is about to expire. In that case, the EE sends a key update request (KUR) message to the CMP server. The server replies with a KUP message carrying the new certificate, along with the related trust chain.

Operators usually generate the new TA certificate before the current TA certificate is about to expire to allow for a smooth migration, i.e. the old TA certificate and the new TA certificate have an overlapping life time.

According to exemplary embodiments of the present invention, the KUP message may be utilized to carry the new TA to be used by the EE for the migration to the new PKI.

Namely, according to exemplary embodiments of the present invention, the TA certificate may be carried by the KUP message in the caPubs field. RFC 4210 so far describes this field to be used only in use during initial registration, while not explicitly excluding the usage for other purposes. The used caPubs field is protected by means of the PKIProtection the CMP server created for the message, therefore the EE can interpret their existence as a trigger by the CMP server to trust the received TA.

Further, according to still further exemplary embodiments of the present invention, the TA certificate may be carried by the KUP message by adding an abstract syntax notation number 1 (ASN.1) “CA Key Update Announcement Content” (CAKeyUpdAnnContent) sequence and its associated object identifier (OID) within an ASN.1 InfoTypeAndValue sequence in the generalInfo field of the CMP messages PKIHeader. This CAKeyUpdAnnContent and the associated OID is already specified in RFC 4210 while it was not foreseen that it could be transported in this way. Using the CAKeyUpdAnnContent sequence also requires the mutual cross-certification of the new and old TAs.

Further, according to still further exemplary embodiments of the present invention, the TA certificate may be carried by the KUP message by re-using an already existing or specifying, proprietary ASN.1 field and associated OID to be used for trust anchors and place it in the generalInfo field. This would e.g. allow for the TAs not needing to be cross-certified. An example for already existing fields would be the TrustAnchorList as specified with OID 1.2.840.113549.1.9.16.1.34 in RFC 5914. The used field(s) is(are) protected by means of the PKIProtection the CMP server created for the message, therefore the EE can interpret their existence as a trigger by the CMP server to trust the received TA.

Further, according to still further exemplary embodiments of the present invention, the TA certificate may be carried by the KUP message by usage of extraCerts. This requires a trustable trigger to inform the EE to utilize the new TA.

For security reasons, it is noted that in case of certificate-based message protection, to avoid impersonation and therefore fraudulent injection of a trust anchor, the EE must have means to unambiguously identify the CMP server by means of its certificate. This can be done e.g. by means of the EE knowing the CMP servers unique subject name or relevant part of it, policy OIDs embedded in the CMP server certificate, etc.

According to preferred embodiments of the present invention to solve the above identified problems, automatic TA lifecycle management is implemented in the CA and the new TA is conveyed via adding an ASN.1 “CA Key Update Announcement Content” (CAKeyUpdAnnContent) sequence in the CMP initialization and key update sequences.

The above-described procedures and functions may be implemented by respective functional elements, processors, or the like, as described below.

In the foregoing exemplary description of the network entity, only the units that are relevant for understanding the principles of the invention have been described using functional blocks. The network entity may comprise further units that are necessary for its respective operation. However, a description of these units is omitted in this specification. The arrangement of the functional blocks of the devices is not construed to limit the invention, and the functions may be performed by one block or further split into sub-blocks.

When in the foregoing description it is stated that the apparatus, i.e. network entity (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e. the expression “unit configured to” is construed to be equivalent to an expression such as “means for”).

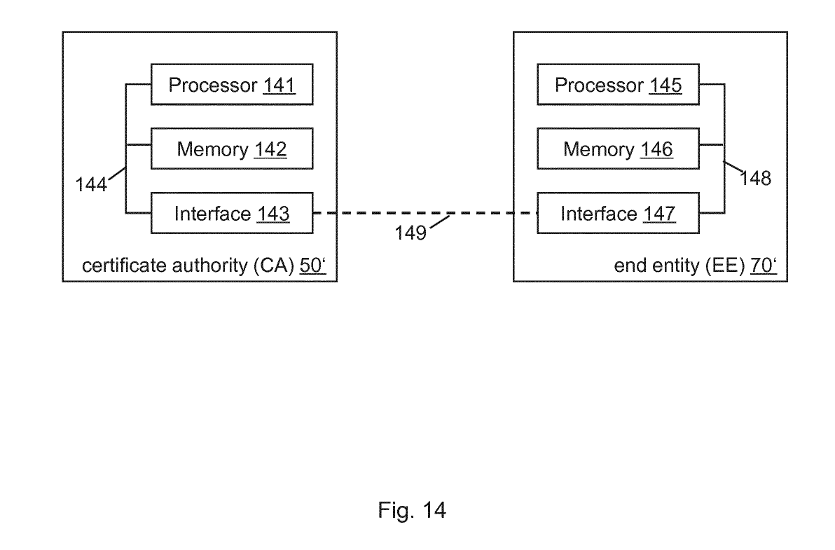

In FIG. 14, an alternative illustration of apparatuses according to exemplary embodiments of the present invention is depicted. As indicated in FIG. 14, according to exemplary embodiments of the present invention, the apparatus (certificate authority) 50′ (corresponding to the certificate authority 50) comprises a processor 141, a memory 142 and an interface 143, which are connected by a bus 144 or the like. Further, according to exemplary embodiments of the present invention, the apparatus (end entity) 70′ (corresponding to the end entity 70) comprises a processor 145, a memory 146 and an interface 147, which are connected by a bus 148 or the like, and the apparatuses may be connected via link 149, respectively.

The processor 141/145 and/or the interface 143/147 may also include a modem or the like to facilitate communication over a (hardwire or wireless) link, respectively. The interface 143/147 may include a suitable transceiver coupled to one or more antennas or communication means for (hardwire or wireless) communications with the linked or connected device(s), respectively. The interface 143/147 is generally configured to communicate with at least one other apparatus, i.e. the interface thereof.

The memory 142/146 may store respective programs assumed to include program instructions or computer program code that, when executed by the respective processor, enables the respective electronic device or apparatus to operate in accordance with the exemplary embodiments of the present invention.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processor (or some other means) is configured to perform some function, this is to be construed to be equivalent to a description stating that at least one processor, potentially in cooperation with computer program code stored in the memory of the respective apparatus, is configured to cause the apparatus to perform at least the thus mentioned function. Also, such function is to be construed to be equivalently implementable by specifically configured means for performing the respective function (i.e. the expression “processor configured to [cause the apparatus to] perform xxx-ing” is construed to be equivalent to an expression such as “means for xxx-ing”).

According to exemplary embodiments of the present invention, an apparatus representing the certificate authority 50 comprises at least one processor 141, at least one memory 142 including computer program code, and at least one interface 143 configured for communication with at least another apparatus. The processor (i.e. the at least one processor 141, with the at least one memory 142 and the computer program code) is configured to perform, for managing, in a network utilizing authentication based on certificates for secure connections between end entities, an update from an old trusted anchor certificate to a new trusted anchor certificate, wherein each of said trusted anchor certificates is a root point of a chain of certificates, providing, for a pre-migration period, said old trusted anchor certificate as valid (thus the apparatus comprising corresponding means for providing), to perform providing, for a migration period, said old trusted anchor certificate and said new trusted anchor certificate, coincidentally, as valid, and to perform providing, for a post-migration period, said new trusted anchor certificate as valid.

According to exemplary embodiments of the present invention, an apparatus representing the end entity 70 comprises at least one processor 145, at least one memory 146 including computer program code, and at least one interface 147 configured for communication with at least another apparatus. The processor (i.e. the at least one processor 145, with the at least one memory 146 and the computer program code) is configured to perform, for updating, in a network utilizing authentication based on certificates for secure connections between end entities, from an old trusted anchor certificate to a new trusted anchor certificate, wherein each of said trusted anchor certificates is a root point of a chain of certificates, conducting a secure connection, wherein, for a migration period, said old trusted anchor certificate and said new trusted anchor certificate are coincidentally valid for said conducting (thus the apparatus comprising corresponding means for conducting).

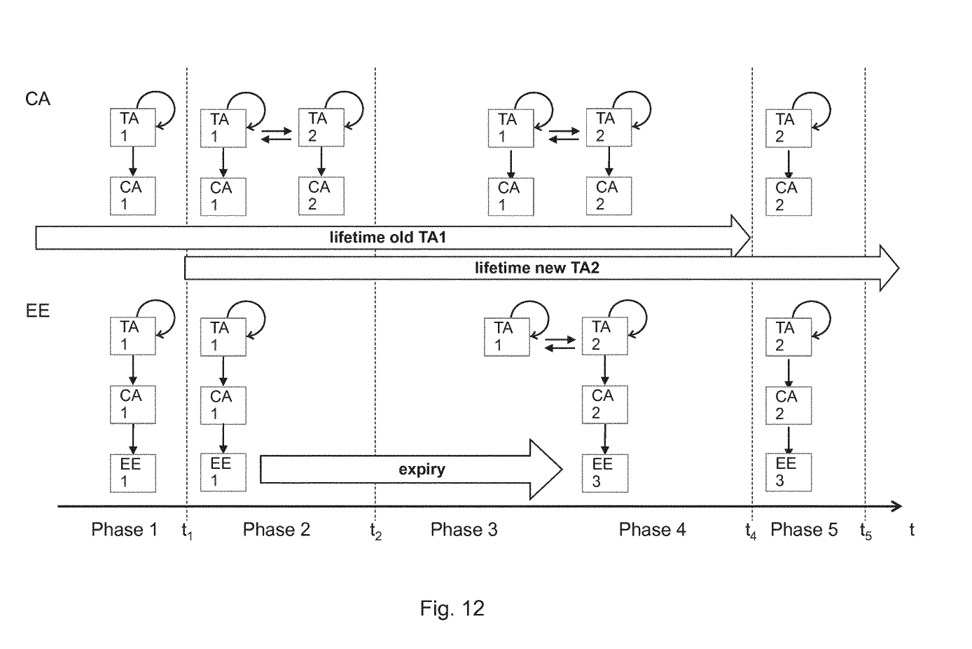

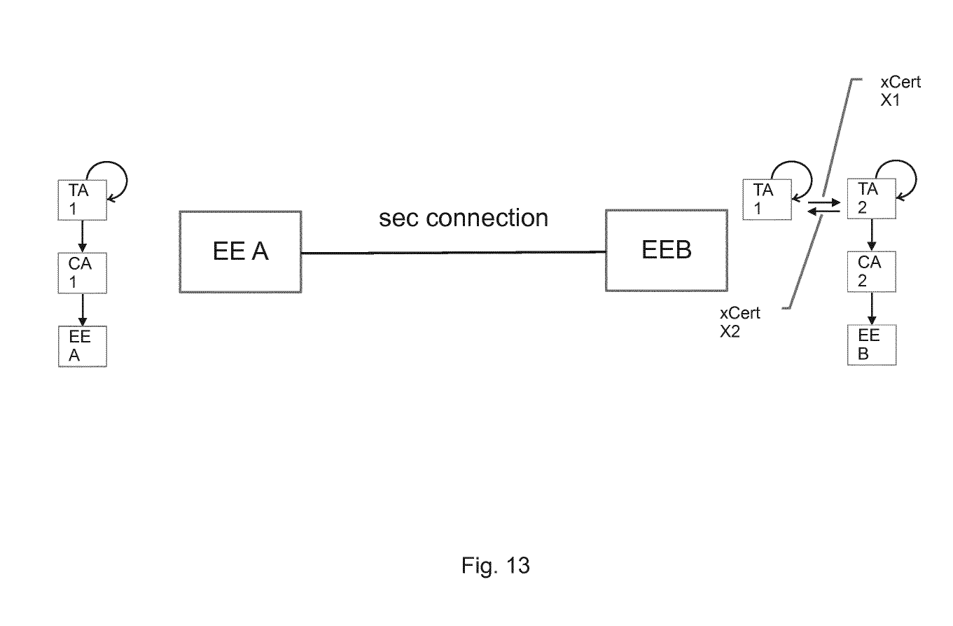

For further details regarding the operability/functionality of the individual apparatuses, reference is made to the above description in connection with any one of FIGS. 5 to 13, respectively.

For the purpose of the present invention as described herein above, it should be noted that
method steps likely to be implemented as software code portions and being run using a processor at a network server or network entity (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined network entity or network register, or any one of their respective units/means) can be implemented as individual devices, units or means, but this does not exclude that they are implemented in a distributed fashion throughout the system, as long as the functionality of the device, unit or means is preserved;
an apparatus like the user equipment and the network entity/network register may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

In view of the above, there are provided measures for trust anchor update in a public key infrastructure. Such measures exemplarily comprise, for managing, in a network utilizing authentication based on certificates for secure connections between end entities, an update from an old trusted anchor certificate to a new trusted anchor certificate, wherein each of said trusted anchor certificates is a root point of a chain of certificates, providing, for a pre-migration period, (only) said old trusted anchor certificate as valid, providing, for a migration period, said old trusted anchor certificate and said new trusted anchor certificate, coincidentally, as valid, and providing, for a post-migration period, (only) said new trusted anchor certificate as valid.

Even though the invention is described above with reference to the examples according to the accompanying drawings, it is to be understood that the invention is not restricted thereto. Rather, it is apparent to those skilled in the art that the present invention can be modified in many ways without departing from the scope of the inventive idea as disclosed herein.

### LIST OF ACRONYMS AND ABBREVIATIONS

3GPP 3^{rd} Generation Partnership Project
AKI authority key identifier
ASN.1 abstract syntax notation number 1
CA certificate authority
CMP certificate management protocol
EE end entity
HTTP hypertext transfer protocol
IP internet protocol
IPsec internet protocol security
IR initial request
KUP key update response
KUR key update request
NE network element
OID object identifier
PKI public key infrastructure
RA registration authority
SSL secure sockets layer
TA trust anchor
TLS transport layer security

1.-32. (canceled)

33. A method for managing, in a network utilizing authentication based on certificates for secure connections between end entities, an update from an old trusted anchor certificate to a new trusted anchor certificate, wherein each of said trusted anchor certificates is a root point of a chain of certificates, said method comprises
providing, for a pre-migration period, only said old trusted anchor certificate as valid,
providing, for a migration period, said old trusted anchor certificate and said new trusted anchor certificate, coincidentally, as valid, and
providing, for a post-migration period, only said new trusted anchor certificate as valid.

34. The method according to claim 33, wherein
in relation to said providing for said pre-migration period, said method further comprises
generating a first certificate authority certificate signed with a private key related to said old trusted anchor certificate,
generating a first end entity certificate signed with a private key related to said first certificate authority certificate, wherein said first end entity certificate is set up to expire within said migration period, and
transmitting said old trusted anchor certificate, said first certificate authority certificate, and said first end entity certificate.

35. The method according to claim 34, wherein
in relation to said providing for said migration period, said method further comprises:
creating said new trusted anchor certificate; and
generating a second certificate authority certificate signed with a private key related to said new trusted anchor certificate.

36. The method according to claim 35, wherein
in relation to said providing for said migration period, said method further comprises
creating a first cross-certificate by signing said old trusted anchor certificate with said new trusted anchor certificate, and
creating a second cross-certificate by signing said new trusted anchor certificate with said old trusted anchor certificate.

37. The method according to claim 35, wherein
said migration period comprises a deployment phase and a change over phase, wherein
said first end entity certificate is set up to expire within said deployment phase, and wherein
in relation to said providing for said migration period, said method further comprises during said deployment phase
generating a second end entity certificate signed with the private key related to said first certificate authority certificate, wherein said second end entity certificate is set up to expire within said change over phase, and
transmitting said new trusted anchor certificate and said second end entity certificate.

38. The method according to claim 37, wherein
in relation to said providing for said migration period, said method further comprises during said change over phase
generating a third end entity certificate signed with a private key related to said second certificate authority certificate, and
transmitting said second certificate authority certificate and said third end entity certificate.

39. The method according to claim 33, wherein
in relation to said providing for said post-migration period, said method further comprises
removing said old trusted anchor certificate.

40. A method for updating, in a network utilizing authentication based on certificates for secure connections between end entities, from an old trusted anchor certificate to a new trusted anchor certificate, wherein each of said trusted anchor certificates is a root point of a chain of certificates, said method comprises
conducting a secure connection, wherein
for a migration period, said old trusted anchor certificate and said new trusted anchor certificate are coincidentally valid for said conducting.

41. The method according to claim 40, further comprising
receiving, during a pre-migration period, a first end entity certificate signed with a private key related to a first certificate authority certificate signed with a private key related to said old trusted anchor certificate, wherein said first end entity certificate is set up to expire within said migration period, and
utilizing said first end entity certificate for establishment and/or re-establishment of said secure connection during said pre-migration period.

42. The method according to claim 41, wherein
said migration period comprises a deployment phase and a change over phase, wherein
said first end entity certificate is set up to expire within said deployment phase, and wherein
said method further comprises
receiving, during said deployment phase, said new trusted anchor certificate and a second end entity certificate signed with the private key related to said first certificate authority certificate, wherein said second end entity certificate is set up to expire within said change over phase, and
utilizing said second end entity certificate for establishment and/or re-establishment of said secure connection during said deployment phase.

43. The method according to claim 42, further comprising
receiving, during said change over phase, a second certificate authority certificate signed with a private key related to said new trusted anchor certificate, and a third end entity certificate signed with a private key related to said second certificate authority certificate, and
utilizing said third end entity certificate for establishment and/or re-establishment of said secure connection during said change over phase.

44. The method according to claim 40, further comprising
removing said old trusted anchor certificate during a post-migration period.

45. An apparatus for managing, in a network utilizing authentication based on certificates for secure connections between end entities, an update from an old trusted anchor certificate to a new trusted anchor certificate, wherein each of said trusted anchor certificates is a root point of a chain of certificates, said apparatus comprises
providing means configured to
provide, for a pre-migration period, only said old trusted anchor certificate as valid, to
provide, for a migration period, said old trusted anchor certificate and said new trusted anchor certificate, coincidentally, as valid, and to
provide, for a post-migration period, only said new trusted anchor certificate as valid.

46. The apparatus according to claim 45, further comprising
generating means configured to
generate, during said pre-migration period, a first certificate authority certificate signed with a private key related to said old trusted anchor certificate, and to
generate, during said pre-migration period, a first end entity certificate signed with a private key related to said first certificate authority certificate, wherein said first end entity certificate is set up to expire within said migration period, and
transmitting means configured to transmit, during said pre-migration period, said old trusted anchor certificate, said first certificate authority certificate, and said first end entity certificate.

47. The apparatus according to claim 46, further comprising
creating means configured to create, during said migration period, said new trusted anchor certificate.

48. The apparatus according to claim 47, further comprising
said generating means is further configured to generate, during said migration period, a second certificate authority certificate signed with a private key related to said new trusted anchor certificate.

49. The apparatus according to claim 46, wherein
said creating means is further configured to
create, during said migration period, a first cross-certificate by signing said old trusted anchor certificate with said new trusted anchor certificate, and to
create, during said migration period, a second cross-certificate by signing said new trusted anchor certificate with said old trusted anchor certificate.

50. The apparatus according to claim 47, wherein
said migration period comprises a deployment phase and a change over phase, wherein
said first end entity certificate is set up to expire within said deployment phase, and wherein
said generating means is further configured to generate, during said deployment phase, a second end entity certificate signed with the private key related to said first certificate authority certificate, wherein said second end entity certificate is set up to expire within said change over phase, and
said transmitting means is further configured to transmit, during said deployment phase, said new trusted anchor certificate and said second end entity certificate.

51. The apparatus according to claim 47, wherein
said generating means is further configured to generate, during said change over phase, a third end entity certificate signed with a private key related to said second certificate authority certificate, and
said transmitting means is further configured to transmit, during said change over phase, said second certificate authority certificate and said third end entity certificate.

52. The apparatus according to claim 45, further comprising
removing means configured to remove, during said post-migration period, said old trusted anchor certificate.
